(19) United States
(12) Patent Application Publication
(10) Pub. No.: US 2017/0110010 A1
(43) Pub. Date: Apr. 20, 2017

(54) METHOD FOR ANALYZING A TRAFFIC SITUATION IN AN AREA SURROUNDING A VEHICLE

(71) Applicant: Robert Bosch GmbH, Stuttgart (DE)

(72) Inventors: Harald Grabs, Stuttgart (DE); Christian Danz, Stuttgart (DE)

(21) Appl. No.: 15/128,502

(22) PCT Filed: Feb. 3, 2015
(86) PCT No.: PCT/EP2015/052189

§ 371 Date: Sep. 23, 2016

(30) Foreign Application Priority Data
Mar. 31, 2014 (DE) 10 2014 205 953.4

(51) Int. Cl. G08G 1/01; G08G 1/16

(52) U.S. Cl. CPC G08G 1/0129; G08G 1/16

(57) ABSTRACT

A method for analyzing a traffic situation in an area surrounding a vehicle having a navigation system and a sensor system, the navigation system ascertaining a vehicle position and the sensor system acquiring movement data of the vehicle and determining a movement behavior of the vehicle in the form of movement trajectories of the vehicle, the vehicle position and the movement trajectories of the vehicle allowing a conclusion about the presence and/or the type of at least one feature in the surrounding area, a sensor of the sensor system detecting the feature and storing at least one item of additional information about the feature.

### FIELD

The present invention relates to a method for analyzing a traffic situation in an area surrounding a vehicle having a navigation system and a sensor system.

### BACKGROUND INFORMATION

It accordance with modern automotive engineering, various methods for driver assistance systems are available to the driver of a vehicle to assist in driving the vehicle.

In this context, certain methods make the driver of the vehicle aware of possible collisions with objects or obstacles in the vicinity of the vehicle. To ensure this, vehicles are equipped, inter alia, with a navigation system as well as a sensor system having various sensors, newer driver assistance systems having, among other things, functions which make it possible to maintain the motor vehicle at a previously defined speed, for example, or to prevent an unintentional departure from the traffic lane.

In addition, certain driver assistance systems either fully automatically or semi-automatically guide the vehicle. For example, both modes of vehicle operation have the goal of making it easier for the driver to drive the vehicle. Thus, for instance, in a traffic jam, the vehicle driver is able to hand over the driving task completely to the driver assistance system for a longer period of time, thus enabling the driver to relieve himself of the driving task. As a result, however, in an emergency situation, the driver is no longer able to react quickly enough in adequate manner, thereby increasing the risk of accident.

To ensure a fully automatic or semi-automatic vehicle operation, it is especially necessary to have knowledge about objects located in the area surrounding the motor vehicle. Information concerning traffic situations in a surrounding area may be provided with the aid of suitable sensor systems such as radar, lidar, ultrasound and/or camera systems. In this context, traffic-signal recognition is a fundamental basis for fully automated driving in urban areas, it being customary to integrate a special camera in the vehicle for recognizing traffic signals.

### SUMMARY

An object of the present invention is to provide an improved method for analyzing a traffic situation in a surrounding area and for assisting a driver in driving a vehicle.

The objective is achieved by a method in accordance with the present invention. Advantageous developments are described herein. Further features and details of the present invention are derived from the description herein and the figures.

The method of the present invention for analyzing a traffic situation in an area surrounding a vehicle having a navigation system and a sensor system is characterized in that the navigation system ascertains a vehicle position and the sensor system acquires movement data of the vehicle and determines a movement behavior of the vehicle in the form of movement trajectories of the vehicle, the vehicle position and the movement trajectories of the vehicle allowing a conclusion about the presence and/or the type of at least one feature in the surrounding area, a sensor of the sensor system detecting the feature and storing at least one item of additional information about the feature. Thus, by evaluating movement data of the vehicle, a conclusion may be drawn about the additional information concerning the feature. Moreover, by combining and comparing a digital map of the navigation system with the evaluated movement trajectories of the vehicle, the information already stored in a navigation system may be improved by the additional information, thereby ensuring, for example, that the position of the feature may be concretized. Consequently, the realization of one of the basic ideas of the invention, which is that a database for the guidance, information and/or navigation of the vehicle may be improved by the acquisition of additional information, is ensured.

The additional information about the feature is stored advantageously as additional information in an internal memory of the navigation system or is transmitted to an external processing unit and stored there. In this way, the additional information about the feature may be stored and used independently of the navigation system or the driver assistance system of the vehicle. In this instance, it is especially advantageous if the external processing unit is located in another vehicle and/or is implemented as a stationary processing unit.

In a further specific embodiment, the additional information includes at least the detected position and type of the feature, the additional information advantageously being transmitted multiple times from one or more vehicles to the external processing unit and stored there, an average value of all detected positions of the feature being stored as position of the feature. In this manner, a more precisely defined position of the feature is able to be stored, the averaging of the position of the feature and/or the averaging of the relative position of the feature advantageously being carried out in the external processing unit, and the external processing unit transmitting the averaged position of the feature to the vehicles. It may thereby be ensured that the position and/or the type of features is/are interchanged among the driver assistance systems of the vehicles, which means the specific information of the navigation systems may be clarified on the basis of the features detected by multiple vehicles, and utilized. In this way, because of the additional information provided by the processing unit, vehicles which have recognized and stored a false feature or even no feature at all are also able to recognize a relevant feature upon passing by the next time or upon passing by for the first time and use it accordingly, depending on the vehicle operation.

A traffic sign and/or a traffic light is/are advantageously detected as feature, in a further specific embodiment, the feature being detected with the aid of a camera system, the various light phases of the traffic light also being determined with the aid of image-processing algorithms of the camera system.

Thus, movement data of a vehicle which is stopping at an intersection or a traffic light or is moving slowly toward such a traffic situation is able to permit a corresponding conclusion about the presence of a traffic situation, and given such a conclusion, the actual presence of a traffic light or a traffic sign is searched for with the aid of the camera system. If the presence is confirmed, the camera system, with the help of image-processing algorithms, determines the light phases of the traffic light or the type of traffic sign and stores this as additional information in the navigation system and/or in the external processing unit, so that the existing digital maps of the navigation system are augmented with the detected features. For example, the position and the type of feature may be determined more precisely, and high quality of the information available may be ensured if many road users having different sensor systems pass by a feature and transmit the detected or ascertained additional information about the feature to the central processing unit.

Especially during fully automated vehicle operation, it is advantageous if the driver assistance system is able to take such additional information into account in advance. To that end, the driver assistance system may receive the information about the position and/or the type of feature from the processing unit and store it in the in-vehicle navigation system or otherwise use it.

Thus, the example method of the present invention closes a fundamental safety gap, so that during fully automated or semi-automatic vehicle operation, the vehicle may be controlled, inter alia, with the aid of the detected features.

It is especially advantageous if the driver assistance system includes a processing device which is equipped to carry out a method indicated above. In this manner, the vehicle may be controlled, e.g., as a function of an early assessment of a virtual light, so that in the case of a traffic light changing to red, the speed of the vehicle may be reduced either directly by the driver assistance system or indirectly by the output of a suitable warning such as an acoustic or visual signal to the vehicle driver, thereby permitting an improvement in driving comfort on one hand, and a reduction in fuel requirement on the other hand.

Correspondingly, it is especially advantageous that an external processing unit is designed to receive at least one item of additional information about a feature in the surrounding area detected by a vehicle, store it, and transmit it to a vehicle, the external processing unit additionally being designed to average various items of transmitted additional information about the same feature, and to send the averaged and therefore revised and clarified additional information back to vehicles.

Further advantages, features and possible applications of the present invention are derived from the description below of exemplary embodiments of the present invention and is illustrated in the figure. At the same time, it should be noted that the features illustrated have only a descriptive character and may also be used in combination with features of other further developments described above, and are not intended to limit the present invention in any way, shape or form.

### BRIEF DESCRIPTION OF THE DRAWING

The present invention is explained in greater detail below on the basis of preferred exemplary embodiments.

FIG. 1 shows an illustration of a traffic situation.

### DETAILED DESCRIPTION OF EXAMPLE EMBODIMENTS

Hereinafter, identical reference numerals are used for identical features.

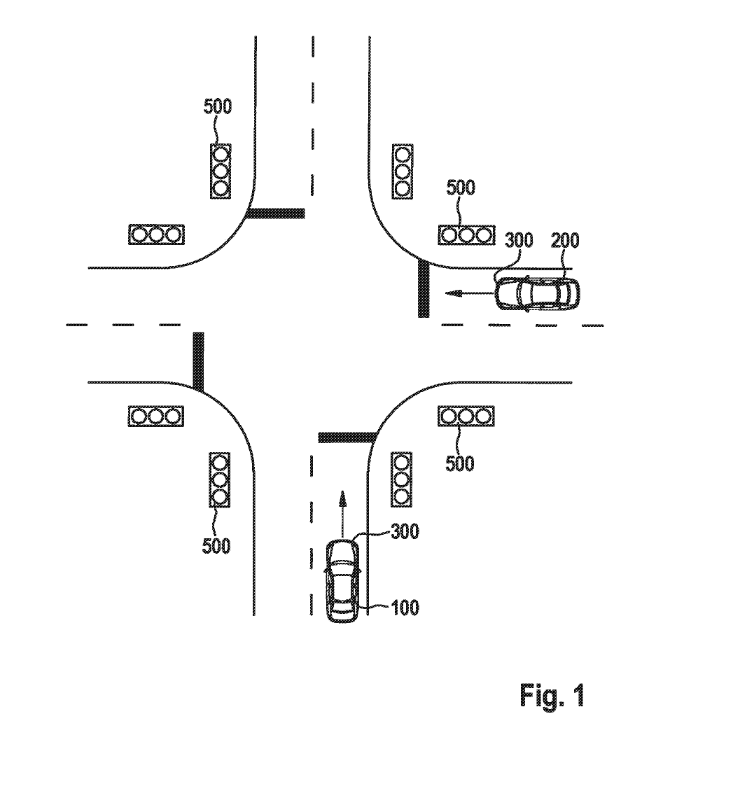

FIG. 1 shows an exemplary traffic situation at an intersection between a first vehicle 100 and a second vehicle 200. Each vehicle 100, 200 has an incorporated driver assistance system which makes it possible to analyze, thus to sense a driving environment of the respective vehicle with the aid of sensor systems. In this case, the sensor systems have a plurality of sensors 300, preferably radar, ultrasonic, lidar, laser and/or video sensors as well as digital maps, the sensor systems in particular thereby being able to detect the state of respective vehicles 100, 200 and a state of the respective driving environment of vehicles 100, 200.

The sensor systems also acquire the movement data of respective vehicles 100, 200, and in light of the data, determine a movement behavior of corresponding vehicles 100, 200 in the form of movement trajectories.

In addition to the acquired movement data, the sensor system is able to detect at least one feature 500 in the surrounding area, the determined and evaluated movement trajectories of the vehicles permitting a conclusion about the presence and/or the type of the feature. The respective travel movements and therefore the movement trajectories of vehicles 100, 200 are thus determined or calculated on the basis of the driving-environment information and on the basis of the vehicle information of the driver assistance systems.

The positions of detected features 500 are subsequently checked for plausibility by comparing the digital maps to the evaluated movement trajectories of respective vehicles 100, 200, mapped in the navigation system and stored as additional information.

Furthermore, the actual traffic situation is checked based on the digital map and with the aid of a camera system. Thus, if vehicles are moving toward an intersection or a traffic light and are becoming slower accordingly, a presence of such a traffic light, an intersection or a traffic sign may be inferred on the basis of the specific travel movements and movement trajectories. As a result of such a conclusion, the camera system searches for the actual presence of such a traffic light, an intersection or a traffic sign, which may be identified with the help of image-processing algorithms of the camera system.

The additional information about the traffic light, the intersection or the traffic sign, such as the position, the location, the height, the lane allocation or the traffic-light phases, is transmitted as additional information to the navigation system and/or to an external processing unit and stored there. In this context, in the event a feature is sensed multiple times, an average value of all sensings is stored, the averaging of the sensings and/or the averaging of the relative position of the feature being carried out in the external processing unit. Subsequently, or as soon as a suitable confidence level of the stored and averaged data is achieved, the data is sent back by the external processing unit to the vehicles, so that the digital maps of the navigation systems are updated with all ascertained and acquired additional information. In so doing, the additional information may be transmitted or exchanged by the use of so-called vehicle-to-vehicle communication, pedestrian-to-vehicle communication, cyclist-to-vehicle communication and/or by an infrastructure-to-vehicle communication, thus, between the infrastructure and the road users located in the surrounding area.

Such a comparison of the digital maps of the navigation systems with the evaluated movement trajectories of vehicles 100, 200 is able to ensure that the information already stored in the navigation systems is improved and concretized, thereby ensuring that the traffic lights, intersections or traffic signs located in the area surrounding vehicles 100, 200 are able to be stored in the navigation system and used during automated vehicle operation.

The vehicle, on the basis of the relative position of feature 500 in terms of the additional information about feature 500 detected by the camera system, upon detecting the feature, is able to improve the determination of its relative position compared to the stored averaged position, thereby permitting a more precise determination of the absolute and the relative position of the feature. Thus, inaccuracies in the GPS-based position finding of the navigation system may be corrected with the aid of the additional information, and the additional information ascertained and acquired from the method may be used for the information and/or for the warning of the drivers of vehicles 100, 200 and/or for the autonomous control of vehicles 100, 200.

The present invention is not limited to the exemplary embodiment described, but rather also includes further specific embodiments achieving substantially the same result. The figure description is intended only to aid in comprehending the present invention.

1-13. (canceled)

14. A method for analyzing a traffic situation in an area surrounding a vehicle having a navigation system and a sensor system, the method comprising:
ascertaining, by the navigation system, a vehicle position;
acquiring, by the sensor system, movement data of the vehicle and determining a movement behavior of the vehicle in the form of movement trajectories of the vehicle, the vehicle position and the movement trajectories of the vehicle allowing a conclusion about at least one of a presence and a type of at least one feature in the surrounding area; and
detecting, by a sensor of the sensor system, the feature and storing at least one item of additional information about the feature.

15. The method as recited in claim 14, wherein the additional information is stored in an internal memory of the navigation system.

16. The method as recited in claim 14, wherein the additional information is transmitted to an external processing unit and is stored there.

17. The method as recited in claim 16, wherein the external processing unit is located in at least one of: i) another vehicle, and ii) is implemented as a stationary processing unit.

18. The method as recited in claim 13, wherein the additional information includes at least a detected position of the feature and a type of the feature.

19. The method as recited in claim 13, wherein the additional information is detected multiple times by one or more vehicles, transmitted to an external processing unit and stored there, an average value of all detected positions of the feature being stored as position of the feature.

20. The method as recited in claim 19, wherein at least one of: i) an averaging of the position of the feature, and ii) an averaging of the relative position of the feature, is carried out in the external processing unit, and the external processing unit transmits the averaged position of the feature to the vehicles.

21. The method as recited in claim 14, wherein the detected feature is at least one of a traffic sign and a traffic light.

22. The method as recited in claim 14, wherein the feature is detected by at least one camera sensor.

23. The method as recited in claim 22, wherein light phases of the traffic light are determined with the aid of image-processing algorithms.

24. A driver assistance system for a vehicle, including a processing device, the processing device designed to analyzing a traffic situation in an area surrounding a vehicle, including:
ascertain a vehicle position;
acquire, from a sensor system, movement data of the vehicle and determine a movement behavior of the vehicle in the form of movement trajectories of the vehicle, the vehicle position and the movement trajectories of the vehicle allowing a conclusion about at least one of a presence and a type of at least one feature in the surrounding area; and
cause detection, by a sensor of the sensor system, of the feature and store at least one item of additional information about the feature.

25. An external processing unit which is designed to receive at least one item of additional information about a feature in the surrounding area detected by a vehicle, to store it, and to transmit it to a vehicle.

26. The external processing unit as recited in claim 25, wherein the processing unit is designed to average various items of transmitted additional information about the same feature, and to transmit the averaged additional information back to vehicles.
